(19) United States
(12) Patent Application Publication
(10) Pub. No.: US 2001/0037790 A1
(43) Pub. Date: Nov. 8, 2001

(54) Lubrication system for marine engine

(76) Inventors: Takayuki Sato, Hamamatsu (JP); Takao Nagai, Hamamatsu (JP)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/838,901

(22) Filed: Apr. 19, 2001

(30) Foreign Application Priority Data
Apr. 19, 2000 (JP) 2000-117422

(51) Int. Cl. F02B 33/04; F01M 3/02; F01M 1/00

(52) U.S. Cl. 123/196 R; 123/196 W; 123/73 AD

(57) ABSTRACT

An internal combustion engine comprises a lubrication system having a crankcase lubricant delivery port adapted to deliver lubricant to engine components within a crankcase chamber and a cylinder lubricant delivery port adapted to deliver lubricant to engine components within a cylinder bore. In engines having inclined or horizontal cylinders, a cylinder lubricant delivery port can be formed through an uppermost wall of the cylinder, and lubricant distribution is aided by gravity. A different volume of lubricant may be delivered to the crankcase lubricant delivery port than is delivered to the cylinder delivery port. The present invention has particular advantages for use in two-cycle, direct-injected engines.

### PRIORITY INFORMATION

This application is based on and claims priority to Japanese Patent Application No. 2000-117422, filed Apr. 19, 2000, the entire contents of which is hereby expressly incorporated by reference.

### BACKGROUND OF THE INVENTION

1. Field of the Invention

This invention relates to a lubrication system for an internal combustion engine. More particularly, the present invention relates to a lubrication system for supplying lubricant to engine components within the cylinders and crankcase of an engine.

2. Description of Related Art

Typically, an outboard motor comprises an engine disposed atop a drive unit of the motor. To propel the associated watercraft, the engine drives a propulsion device placed in a submerged position through a proper drive mechanism. The engine usually has an engine body and a plurality of components. The engine body normally comprises a cylinder block, a cylinder head assembly and a crankcase assembly. At least one combustion chamber, and often more than one combustion chamber, is provided within the engine.

Two cycle internal combustion engines are often employed in outboard motors. Such two-cycle engines are typically lubricated by supplying lubricant through the engine's induction and porting system for lubricating the various moving components of the engine. Lubricant can be supplied in a wide variety of manners. For example, lubricant may be mixed with fuel, may be sprayed into the induction system of the engine, may be delivered directly to certain components of the engine, or may be supplied by any combination of the above.

In conventional two cycle engines, air from an air intake system travels through reed valves into a crankcase chamber of the engine. Air from the crankcase chamber is supplied to the cylinders for combustion. Typically, fuel such as gasoline is mixed with lubrication oil and supplied to the air flow on an upstream side of the reed valves. The viscosity of this fuel/lubricant mixture is low in comparison with a typical lubricant taken alone. Because of its low viscosity, the mixture is readily distributed to various components of the engine, such as the crankshaft, piston, connecting rod, and cylinder, to lubricate these components.

In order to reduce unburned hydrocarbons and engine exhaust emissions, and to increase engine performance, many internal combustion engines now employ direct fuel injection, wherein the fuel is directly injected into the cylinders. In these engine arrangements, the fuel is not mixed with lubricant. As a result, the relatively high-viscosity lubricant is injected into the air flow for distribution in the crankcase. Because of its high viscosity, it can be difficult to distribute the lubricant to engine components. This is especially true for engine components located generally within the cylinder bore, such as the piston, cylinder bore, and piston pin, because the lubricant tends to remain in the crankcase chamber.

Accordingly, there is a need in the art for a two-cycle, fuel-injected engine having a lubrication system that provides sufficient lubricant to engine components such as the cylinder bore and piston connecting rods.

### SUMMARY OF THE INVENTION

In accordance with one aspect of the present invention, an internal combustion engine that is adapted to drive a propulsion unit is provided. The engine comprises a crankcase at least partially enclosing a crankshaft, a cylinder block having at least one cylinder bore having an uppermost wall portion, a piston arranged within the cylinder bore to reciprocate therein, and a lubrication system. The lubrication system comprises a first lubricant insertion port and a second lubricant insertion port. The first port is positioned and arranged so as to direct lubricant into the crankcase. The second port opens into the cylinder bore through the uppermost wall of the cylinder bore.

In accordance with another aspect, the present invention provides an internal combustion engine that is configured to drive a propulsion device. The engine comprises a cylinder block having at least one cylinder formed therein. A cylinder liner is disposed in the cylinder and defines a cylinder bore. A piston is arranged within the cylinder bore to reciprocate therein. A lubricant discharge port is formed through the cylinder block and opens into the cylinder. A circumferential passage is formed between the cylinder and the cylinder liner. The circumferential passage is arranged so as to communicate with the cylinder block lubricant discharge port. At least one lubricant delivery hole is formed through the cylinder liner and is positioned to correspond with the circumferential passage. The delivery hole is offset from the lubricant discharge port.

In accordance with yet another aspect of the present invention, an internal combustion engine adapted to drive a propulsion unit comprises a crankcase at least partially enclosing a crankshaft. A cylinder block of the engine has at least one cylinder bore. A piston is arranged within the cylinder bore to reciprocate therein. A lubrication system of the engine includes means for delivering a first volume of lubricant to engine components in the crankcase and separately delivering a second volume of lubricant to engine components within the cylinder bore.

In accordance with still another aspect, the present invention provides an internal combustion engine that is configured to drive a propulsion device. The engine comprises a cylinder block having at least one cylinder formed therein. A cylinder liner is disposed in the cylinder and defines a cylinder bore. A piston is arranged within the cylinder bore to reciprocate therein. A lubricant discharge port is formed through the cylinder block and opens into the cylinder. A circumferential groove is formed in an outer surface of the cylinder liner. The circumferential groove is arranged so as to be in registry with the cylinder block lubricant discharge port. At least one lubricant delivery hole is formed through the cylinder liner and is positioned to correspond with the circumferential groove. The delivery hole is offset from the lubricant discharge port.

Further aspects, features and advantages of this invention will become apparent from the detailed description of the preferred embodiments which follows.

### BRIEF DESCRIPTION OF THE DRAWINGS

These and other features, aspects and advantages of the present invention will now be described with reference to the drawings of a preferred embodiment which is intended to illustrate and not to limit the invention. The drawings comprise 6 figures.

FIG. 1 is a side elevational view of an outboard motor comprising a lubrication system arranged in accordance with a preferred embodiment of the present invention. The lubrication system is illustrated schematically in the figure and actual positioning of respective engine components can differ from those illustrated. A watercraft associated with the outboard motor also is partially shown in section.

FIG. 2A is a schematic top plan view of a conventional two-cycle engine wherein a fuel/oil mixture is inserted into an air intake system upstream of the crankcase chamber.

FIG. 2B is a schematic top plan view of a conventional two-cycle engine wherein fuel is injected directly into a combustion chamber and lubricant is inserted into an air intake system upstream of the crankcase chamber.

FIG. 3 is a schematic top plan view of a two-cycle, direct-injected engine having features in accordance with the present invention.

FIG. 4 is a sectional view of a cylinder bore and cylinder liner having features in accordance with the present invention.

FIG. 5A is a side sectional view of a cylinder liner having features in accordance with the present invention.

FIG. 5B shows another view of the liner of 5A as if the liner has been cut and flattened.

FIG. 5C shows the liner of FIG. 5A taken along lines 5c-5c.

FIG. 6A shows a close-up sectional view of a cylinder block and crankcase having features in accordance with the present invention, shown with the piston at the top dead center position.

FIG. 6B shows the arrangement of FIG. 6A with the piston at a middle position.

FIG. 6C shows the arrangement of FIG. 6A with the piston at the bottom dead center position.

### DETAILED DESCRIPTION OF THE PREFERRED EMBODIMENTS OF THE INVENTION

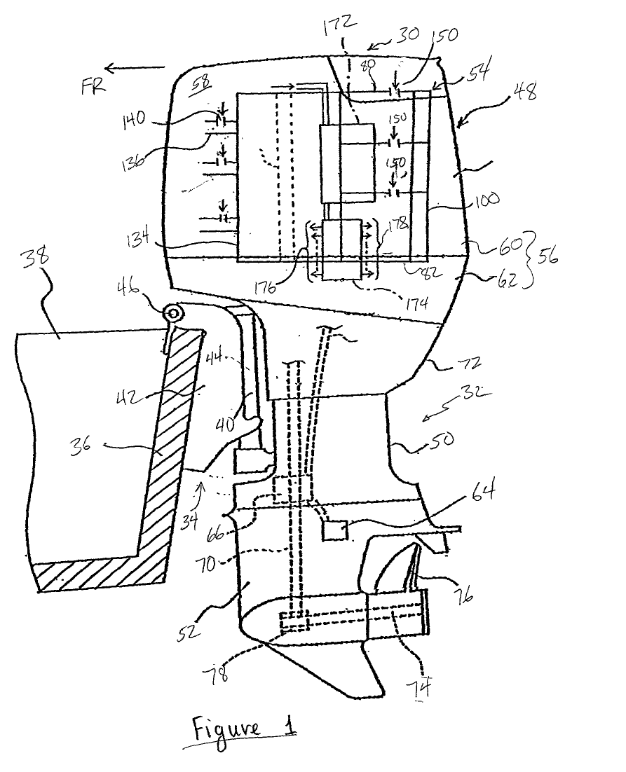

With reference to FIGS. 1-3, an overall construction of an outboard motor 30, which employs a lubrication system arranged in accordance with certain features, aspects and advantages of the present invention, will be described. In the illustrated arrangement, the outboard motor 30 comprises a drive unit 32 and a bracket assembly 34. The bracket assembly 34 supports the drive unit 32 on a transom 36 of an associated watercraft 38 and places a marine propulsion device in a submerged position with the watercraft 38 resting on the surface of a body of water. The bracket assembly 34 preferably comprises a swivel bracket 40, a clamping bracket 42, a steering shaft 44 and a pivot pin 46.

The steering shaft 44 typically extends through the swivel bracket 40 and is affixed to the drive unit 32. The steering shaft 44 is pivotally journaled for steering movement about a generally vertically-extending steering axis defined within the swivel bracket 40. The clamping bracket 42 comprises a pair of bracket arms that are spaced apart from each other and that are affixed to the watercraft transom 36. The pivot pin 46 completes a hinge coupling between the swivel bracket 40 and the clamping bracket 42. The pivot pin 46 extends through the bracket arms so that the clamping bracket 42 supports the swivel bracket 40 for pivotal movement about a generally horizontally-extending tilt axis defined by the pivot pin 46. The drive unit 32 thus can be tilted or trimmed about the pivot pin 46.

As used through this description, the terms “forward,” “forwardly” and “front” mean at or to the side where the bracket assembly 36 is located, and the terms “rear,” “reverse,” “backwardly” and “rearwardly” mean at or to the opposite side of the front side, unless indicated otherwise or otherwise readily apparent from the context use.

A hydraulic tilt and trim adjustment system preferably is provided between the swivel bracket 40 and the clamping bracket 42 to tilt (raise or lower) the swivel bracket 40 and the drive unit 32 relative to the clamping bracket 42. Otherwise, the outboard motor 30 can have a manually operated system for tilting the drive unit 32. Typically, the term “tilt movement”, when used in a broad sense, comprises both a tilt movement and a trim adjustment movement.

The illustrated drive unit 32 comprises a power head 48, a driveshaft housing 50 and a lower unit 52. The power head 48 is disposed atop the drive unit 32 and comprises an internal combustion engine 54 that is positioned within a protective cowling 56. Preferably, the protective cowling 56 defines a generally closed cavity 58 in which the engine 54 is disposed. The protective cowling 56 preferably comprises a top cowling member 60 and a bottom cowling member 62. The top cowling member 60 is preferably detachably affixed to the bottom cowling 62 by a coupling mechanism (not shown) so that a user, operator, mechanic or repair person can access the engine 54 for maintenance or for other purposes.

The top cowling 60 preferably has at least one air intake opening and at least one air duct disposed on its rear and top portion. Ambient air is drawn into the closed cavity 58 from within the opening through the duct.

An open loop cooling system is provided to guide cooling water through water jackets preferably formed adjacent certain engine components so as to remove at least some heat that may accumulate in those engine components. In the open loop cooling system, cooling water is drawn into the cooling system through a water inlet 64 from the body of water surrounding the outboard motor 30 by a water pump 66. The water inlet 64 is disposed in a portion of the lower unit 52 that preferably is positioned under the water line at a level that will generally remain submerged when the drive unit 32 is fully or almost fully tilted down. The water pump 66, in turn, is disposed in the driveshaft housing 50. After flowing through the water jackets, the cooling water is returned to the body of water through a discharge port or by being directed into the exhaust system.

The driveshaft housing 50 depends from the power head 48 and supports a driveshaft 70 which is driven by a crankshaft of the engine. The driveshaft 70 extends generally vertically through the driveshaft housing 50. The driveshaft 70 preferably drives the water pump 66. An apron 72 covers an upper portion of the driveshaft housing 50 and improves the overall appearance of the outboard motor.

The lower unit 52 depends from the driveshaft housing 50 and supports a propulsion shaft 74, which is driven by the driveshaft 70. The propulsion shaft 74 extends generally horizontally through the lower unit 52. A propulsion device is attached to the propulsion shaft 74 and is powered through the propulsion shaft 74. In the illustrated arrangement, the propulsion device is a propeller 76 that is affixed to an outer end of the propulsion shaft 74. The propulsion device, however, can take the form of a dual counter-rotating system, a hydrodynamic jet, or any of a number of other suitable propulsion devices.

A transmission 78 preferably is provided between the driveshaft 70 and the propulsion shaft 74. The transmission 78 couples together the two shafts 70, 74, which lie generally normal to each other (i.e., at a 90° shaft angle) with bevel gears. The outboard motor 30 has a switchover or clutch mechanism that allows the transmission 78 to change the rotational direction of the propeller 76 among forward, neutral or reverse.

In the illustrated embodiment, the internal combustion engine 54 is a V-6 type and operates on a two-stroke, crankcase-compression principle. It is to be understood that the actual number of cylinders and the cylinder configuration may vary. For example, an inline four cylinder engine or a single-cylinder engine may appropriately employ certain aspects of the invention. Four-cycle engines can also use certain aspects of the present invention.

Additionally, the illustrated embodiment describes the internal combustion engine being used in conjunction with an outboard motor. It is to be understood that certain aspects of the present invention may advantageously be used with various types of marine drives, such as inboard and inboard/outboard drives.

The V-6 engine 54 preferably has a right (starboard) and left (port) side and includes a cylinder block 80 having a pair of angularly related cylinder banks 82, each of which includes three cylinder bores 84 formed therein. The cylinder bores 84 extend generally horizontally and are generally vertically spaced from one another. As used in this description, the term “horizontally” means that the subject portions, members or components extend generally parallel to the water line of the body of water wherein the associated watercraft is resting when the drive unit 32 is not tilted and is placed in the position shown in FIG. 1. The term “vertically” in turn means that portions, members or components extend generally normal to those that extend horizontally.

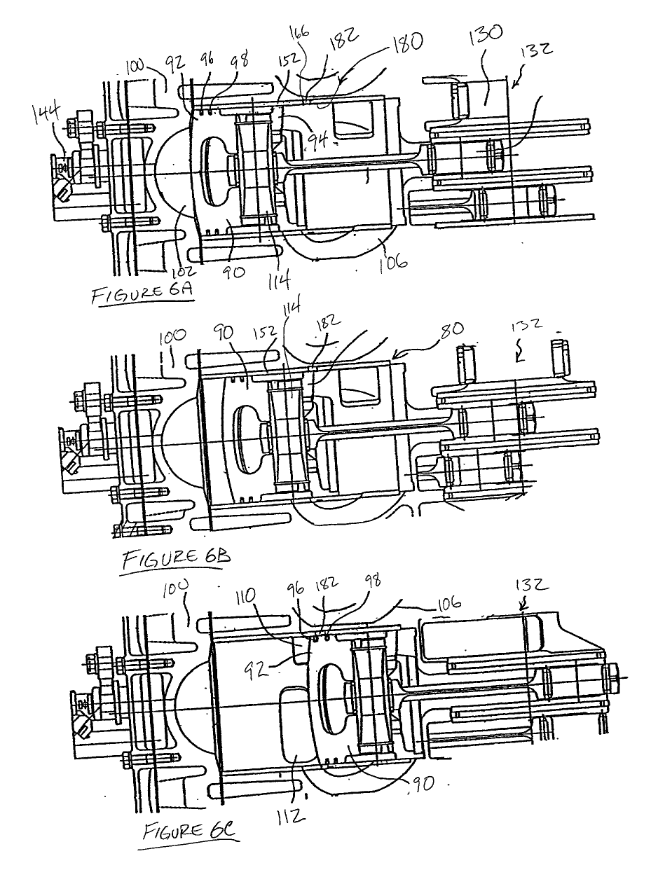

As is typical with V-type engine practice, the cylinders 84 in the cylinder banks 82 are staggered (see FIGS. 6A-6C). Since FIGS. 1 and 6 show only a side view of the engine 54, only the left cylinder bank 82 is depicted in these figures.

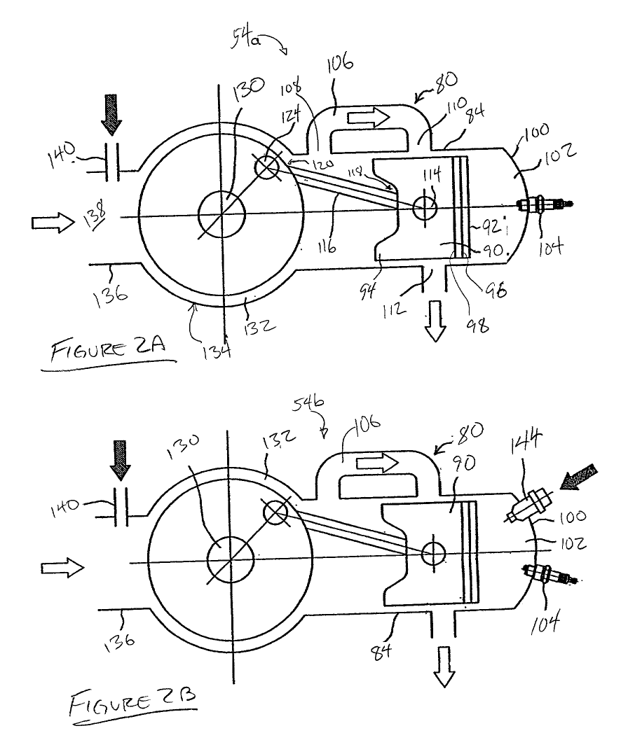

With next reference to FIG. 2A, a conventional two-cycle, crankcase-compression engine 54a is shown schematically. As with the present invention, the conventional two-stroke engine comprises a cylinder block 80 which includes a cylinder bore 84. A piston 90 is disposed within the cylinder bore 84 and is arranged for reciprocating movement therein. The piston 90 has a piston top portion 92 and a piston skirt portion 94. A top ring 96 circumferentially surrounds the piston 90. A bottom ring 98 also circumferentially surrounds the piston 90 and is positioned adjacent the top ring 96 and on a side of the top ring opposite the piston top 92.

A cylinder head 100 is mounted on the cylinder block 80 so as to enclose a combustion chamber 102 between the cylinder head 100, piston top 92 and cylinder bore 84. A spark plug 104 has a spark generating electrode portion which extends through the cylinder head 100 and into the combustion chamber 102.

A scavenge passage 106 is formed in the cylinder block 80 and comprises a scavenge inlet port 108 formed through the cylinder bore 84 and a scavenge outlet port 110 also formed through the cylinder bore 84. An exhaust port 112 is formed through a wall of the cylinder bore 84 and is adapted to allow an exhaust charge to flow therethrough and out of the combustion chamber 102.

The piston 90 is rotatably connected via a piston pin 114 to a connecting rod 116 at a small end 118 of the rod 116. A large end 120 of the connecting rod 116 is connected via a coupling shaft 124 to a throw of a crankshaft 130. As the piston 90 reciprocatingly moves within the cylinder bore 84, the crankshaft 130 correspondingly rotates.

The crankshaft 130 is disposed within a crankcase chamber 132 defined within a crankcase portion 134 of the engine 54a. Typically, in multiple cylinder engines, the crankcase 134 is divided into crankcase chambers, one chamber corresponding to each of the cylinders. The view in FIG. 2A shows one such crankcase chamber/cylinder arrangement.

An air guide 136 is formed as part of the crankcase 134 and is configured so that air from an intake passage 138 flows through a one-way valve and into the crankcase chamber 132. A crankcase lubricant port 140 preferably extends through a wall of the air guide 136 and is configured to insert a mixture of fuel and lubricant into the intake passage 138 upstream of the crankcase chamber 132.

In operation, as the piston 90 moves toward the cylinder head 100 and away from the crankcase chamber 132, an air charge combined with a fuel/oil mixture from the crankcase lubricant port 140 is drawn from the intake passage 138 through the one way valve and into the crankcase chamber 132. The fuel/oil mixture has a relatively low viscosity and is readily distributed by the turning crankshaft 130 and other moving engine components so as to lubricate engine components such as the coupling shaft 124 of the connecting rod 116, the piston pin 114 and the cylinder bore 84 around the piston 90.

As the piston 90 then moves away from the cylinder head 100 and toward the crankcase chamber 132, a fuel/oil/air charge is forced through the scavenge passage 106 and into the combustion chamber 102 between the cylinder head 100 and piston top 92. As the piston 90 again moves toward the cylinder head 100, the fuel/oil/air charge is compressed. The compressed charge is ignited by the spark plug 104 and the burning charge forces the piston 90 toward the crankcase chamber 132. The burnt charge is exhausted out of the exhaust port 112 and is replaced by a new fuel/air charge entering the combustion chamber 102 through the scavenge passage 106.

With next reference to FIG. 2B, a direct-injected, two-cycle engine 54b is structurally substantially similar to the conventional two-cycle engine 54a of FIG. 2A, however, a fuel injector 144 is disposed on the cylinder head 100 and has an injection nozzle configured to spray fuel directly into the associated combustion chamber 102.

Since fuel is injected directly into the combustion chamber 102, it is no longer necessary to mix fuel with the lubricant that is injected into the intake passage 138 upstream of the crankcase chamber 132. Instead, only lubricant is injected through the lubricant delivery port 140. The lubricant is drawn into the crankcase chamber 132 with intake air and is distributed to the engine components to lubricate such components. However, the lubricant oil typically has a much higher viscosity than the fuel/oil mixture of a conventional two-cycle engine 54a; consequently, the lubricant is not distributed as readily as the fuel/oil mixture. The oil tends to accumulate within the crankcase chamber 132, and relatively small quantities flow into the cylinder bore 84 to lubricate the engine components within the cylinder bore. Thus, engine components within the cylinder bore 84, such as the piston pin 114 and the cylinder bore around the piston, are at risk of receiving inadequate lubrication.

Increasing the volume of oil injected into the crankcase chamber 132 can correspondingly increase the volume of oil that flows into the cylinder bore 84 in order to lubricate engine components in the cylinder bore. However, the volume of oil injected into the crankcase chamber 132 in order to provide such lubrication may be excessive. This can lead to undesired consequences such as waste of lubricant and increase in emissions as excess oil is drawn through the combustion chamber and exhausted as unburned hydrocarbons. The unburned hydrocarbons tend to bond with steam so as to generate a foul-odored white smoke. This has a special impact for engines associated with marine drives that are used in water, because the foul-odored smoke can be generated by unburned hydrocarbons in the exhaust that is discharged to the water, thus causing significant discomfort to the user of the marine drive.

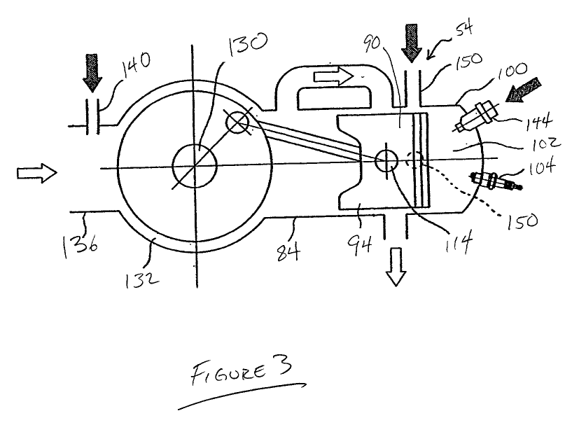

With next reference to FIG. 3, a top schematic view of a two-cycle, direct-injected engine 54 having features in accordance with the present invention is shown. The present engine shares many features in common with a conventional two-cycle, direct-injected engine 54a, however, a lubricant delivery port 150 is formed through the wall of the cylinder bore 84 so as to direct lubricant directly into the cylinder bore 84 and onto the piston 90 and connecting rod 116. It is to be understood that FIG. 3 only schematically shows the present embodiment, and that the lubricant delivery port 150 is not necessarily shown in its correct location relative to other engine components such as the piston and exhaust passage.

A crankcase lubricant delivery port 140 extends into the intake passage 138 to supply oil which will flow with air into the crankcase chamber 132. Thus, lubricant oil is supplied into the crankcase chamber 132 to lubricate engine components within the crankcase 134, such as the coupling shaft 124 of the connecting rod 116 and the crankshaft 130. Lubricant oil is also directed via the cylinder lubricant delivery port 150 into the cylinder bore 84 to lubricate cylinder engine components such as the cylinder bore 84, piston 90, piston pin 114 and piston rings 96, 98. In this manner, a smaller overall volume of lubricant can be inserted into the engine 54 because each lubricant port 140, 150 distributes lubricant over a relatively small area. Thus, lubricant distribution is improved while lubricant waste and volume is decreased.

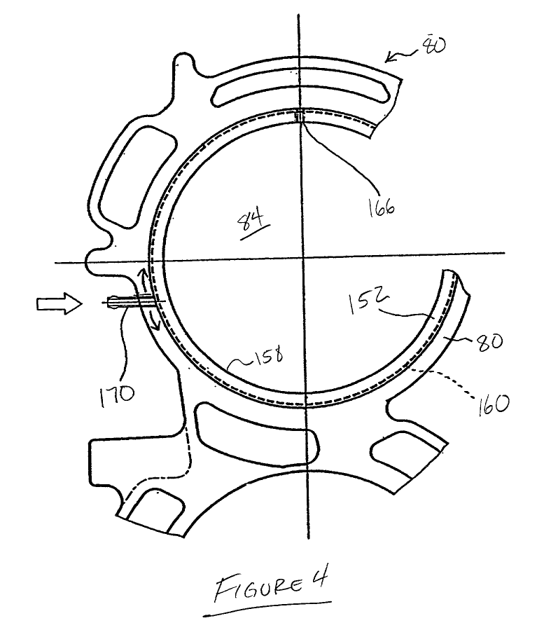

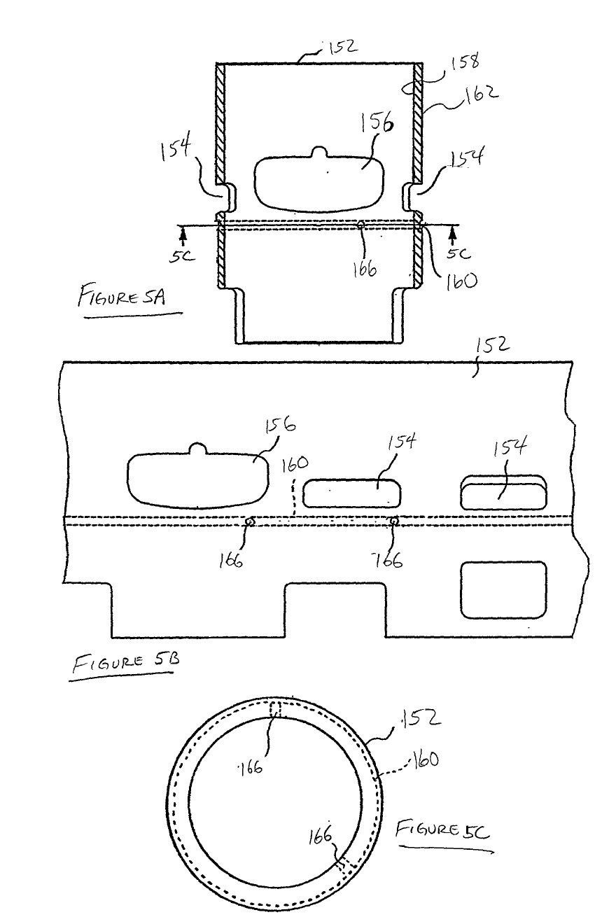

With next reference to FIGS. 4 and 5, a cylinder liner 152 can be inserted into the cylinder block 80 so as to define the cylinder bore 84. The cylinder liner 152 has scavenge ports 154 and an exhaust port 156 which correspond with the scavenge ports 108, 110 and exhaust ports 112 formed in the cylinder block 80. An inner surface 158 of the cylinder liner 152 comprises the surface against which the piston rings 96, 98 slide during reciprocating movement of the piston 90 in the cylinder bore 84. A circumferential groove 160 is formed in an outer surface 162 of the cylinder liner 152. At least one, and more preferably two, oil delivery holes 166 are formed through the cylinder liner 152 and are positioned so as to communicate with the circumferential groove 160.

A lubricant delivery port 170 is formed through the cylinder block 80. The cylinder liner 152 is positioned within the cylinder block 80 so that the circumferential groove 160 registers with the opening of the cylinder block lubricant delivery port 170, but the port is not necessarily aligned with the oil delivery holes 166. As lubricant is delivered through the port 170, it flows into the groove 160, which acts as an oil passage to direct oil to the oil discharge holes 166, through which the oil flows into the cylinder bore 84. In this manner, lubricant is delivered precisely to engine components within the cylinder bore 84.

The circumferential oil passage provides valuable advantages. For example, in some embodiments, it is desired to locate the oil delivery holes 160 at specific locations within the cylinder bore 84. However, machining the cylinder block 80 so as to provide a lubricant delivery port at the desired location may be difficult and expensive. The circumferential oil passage 160 allows the cylinder block port 170 to be provided at an easy-to-manufacture location. Oil delivery from the port 170 to the desired specific locations is accomplished by the oil passage 160 leading to the oil discharge holes 166.

The circumferential nature of the oil passage is also advantageous in that it eases placement of the cylinder liner 152 into the cylinder during engine assembly. If the oil passage were not fully circumferential, special care would have to be taken to ensure that the oil passage 160 is precisely aligned with the cylinder block lubricant port 170 in order to avoid the port not aligning with the passage. Since the oil passage in the illustrated embodiment extends around the entire cylinder liner 152, the cylinder block lubricant delivery port 170 will be appropriately aligned with the oil passage 160 at any location around the circumference of the liner 152 once correct longitudinal positioning of the groove 160 has been achieved. Thus, only coarse alignment is required, and manufacture is thus eased. Still further, if, during engine operation, a portion of the circumferential groove 160 is blocked, the circumferential nature of the groove 160 provides another direction of oil passage that will remain open for delivery of lubricant to the cylinder bore.

Forming the circumferential groove 160 in the cylinder liner 152 rather than the cylinder block 80 is also advantageous. For example, machining the cylinder liner 152 is easier and less expensive than machining or casting a groove into the cylinder block 80.

With reference back to FIG. 1, a lubricant storage tank 172 is preferably disposed within the power head 48 of the outboard motor 30. An oil pump 174 communicates with the oil tank 172 and pumps the lubricant to the lubricant delivery ports 140, 170. In the illustrated embodiment, the oil pump 174 has one outlet port 176 configured to deliver lubricant to an associated crankcase lubricant delivery port 140 and one outlet port 178 configured to deliver lubricant to an associated cylinder bore lubricant delivery port 170. Thus, the oil pump 174 has two outlet ports 176, 178 for each crankcase chamber/cylinder pair.

Since the crankcase chamber is relatively larger than the cylinder bore, it is anticipated that a larger volume of oil is necessary to adequately lubricate the engine components in the crankcase chamber 132 than is necessary to adequately lubricate the engine components in the cylinder bore 84. Accordingly, in the illustrated embodiment, a greater volume of oil is delivered through the crankcase lubricant delivery port 140 than is delivered through the cylinder lubricant delivery port 170. It is also to be understood, however, that in the certain engine types, more lubricant may be required by the cylinder engine components than by the crankcase components. Accordingly, in other embodiments, a higher volume of lubricant may be delivered to the cylinder lubricant delivery port than to the crankcase lubricant delivery port.

Various types of oil pumps arranged in various configurations can be used to deliver oil in any manner desired. For example, a single mechanical pump or electromagnetic pump can be used. In the illustrated embodiment, which includes a V6 engine, the oil pump 174 preferably comprises twelve delivery ports. Six of the ports 176 are adapted to deliver oil to crankcase delivery ports 140 while another six ports 178 are adapted to deliver oil to cylinder lubricant delivery ports 170. In another embodiment, two pumps having six ports each are employed. In still other embodiments, one of the pumps may be adapted to deliver lubricant only to the crankcase lubricant delivery ports, while the other pump is adapted to deliver oil only to the cylinder lubricant delivery ports. As discussed above, these pumps may be adapted to deliver a different volume of lubricant to the crankcase lubricant delivery port than to the cylinder lubricant delivery port. Other exemplary combinations of pumps include a single mechanical pump having six ports and six electromagnetic ports having one port apiece or even 12 electromagnetic pumps each having one port apiece. Still further variations along these lines can also be contemplated.

In the illustrated embodiment, the crankcase lubricant delivery port 140 opens into the intake air guide 136 upstream of the intake valves. It is to be understood that in another embodiment, the crankcase lubricant delivery port 140 can open directly into the crankcase 134, bypassing the intake air guide and the one-way valves.

With reference next to FIGS. 6A-6C, the positioning of the oil delivery holes 166 are described in accordance with another preferred embodiment of the present invention. FIG. 6A shows a cross-sectional side view of the cylinder block 80 showing the cylinder liner 152. In the illustrated embodiment, the cylinder bore 84 is substantially horizontally disposed. The piston 90 is shown in the top dead center position. Due to its horizontal disposition, the cylinder bore 84 has an uppermost wall portion 180. The cylinder liner 152 has an upper oil delivery hole 182 formed through the uppermost wall portion 180 of the cylinder liner. As shown, when the piston 90 is in the top dead center position, the upper delivery hole 182 opens into the cylinder bore 84, and lubricant flows downwardly with gravity into the bore, thus delivering lubricant to components such as the connecting rod 116.

With next reference to FIG. 6B, when the piston 90 is in a middle position, the upper lubricant delivery hole 182 is positioned adjacent the piston skirt 94 so as to discharge lubricant onto the piston skirt 94. Since the port 182 is at the uppermost portion 180 of the liner 152, lubricant will flow downwardly with gravity and will spread across the piston skirt 94 for lubrication.

As the piston 94 continues to move toward the bottom dead center position, the piston pin 114 will move directly below the delivery port 182. Thus, lubricant will be delivered directly to the piston pin 114, lubricating the pin.

With reference next to FIG. 6C, when the piston 90 is in the bottom dead center position, as shown, the delivery hole 182 is positioned between the piston top ring 96 and piston bottom ring 98. Thus, lubricant will be directed into a space between the piston rings 96, 98. As discussed above, since the insertion port 182 is at the uppermost portion 180 of the cylinder liner 152, lubricant will flow downwardly with gravity and will be distributed across the piston 90 between the top and bottom rings 96, 98. Additionally, the rings distribute the lubricant on the cylinder bore 84 along a range of the bore travelled by the piston rings.

The above-described construction facilitates thorough lubrication of the cylinder bore engine components while using a relatively small amount of lubricant because the lubricant is delivered generally directly onto the components that require lubrication. Accordingly, less lubricant is needed overall to lubricate the engine because there is no need for excess lubricant from the crankcase to flow into the cylinders.

As shown in FIGS. 6A-C and as discussed above, positioning the upper oil delivery hole 182 in the uppermost wall portion 180 of a substantially horizontal cylinder liner 152 creates particular advantages because gravity aids distribution of the lubricant. Some engine constructions employ inclined cylinder bores, which also have an uppermost side wall surface. An upper oil delivery hole can also be formed through the upper wall of such an inclined cylinder bore to take advantage of the benefits of gravity as in the horizontally-disposed cylinder bore embodiment discussed above.

The foregoing description discusses several preferred constructions having certain features, aspects and advantages in accordance with the present invention. In addition, not all of the above-described components, features or aspects must be used in a single lubrication system, and a lubrication system can employ various components without employing other components. Still further, although the illustrated constructions were associated with a two-cycle, direct-injected engine, certain features, aspects and advantages can be appropriately used in connection with engines operating on different combustion principles or having different configurations. Thus, various changes and modifications may be made to the above-described arrangements without departing from the spirit and scope of the invention, as defined by the appended claims.

What is claimed is:

1. An internal combustion engine adapted to drive a propulsion unit, the engine comprising a crankcase at least partially enclosing a crankshaft, a cylinder block having at least one cylinder bore having an uppermost wall portion, a piston arranged within the cylinder bore to reciprocate therein, and a lubrication system, the lubrication system comprising a first lubricant insertion port and a second lubricant insertion port, the first port being positioned and arranged so as to direct lubricant into the crankcase, the second port opening into the cylinder bore, the second port opening through the uppermost wall of the cylinder bore.

2. The engine of claim 1, wherein the crankshaft is substantially vertically disposed, and the cylinder bore is substantially horizontally disposed.

3. The engine of claim 1, wherein the piston includes at least one circumferentially disposed ring, and the second port opens into the cylinder bore at a position so that when the piston is at the bottom dead center position, the second port opens adjacent the piston ring, and when the piston is at the top dead center position, the second port opens into the cylinder bore and does not open onto the piston.

4. The engine of claim 3, wherein the piston includes a second circumferentially disposed ring, and the second port opens into a space between the rings when the piston is at the bottom dead center position.

5. The engine of claim 1, wherein the first lubricant port opens into an air intake upstream of the crankcase.

6. The engine of claim 1, wherein the first lubricant port opens directly into the crankcase.

7. The engine of claim 1, wherein the piston is connected to the crankshaft by a connecting rod, and a piston pin connects the piston to the connecting rod, and wherein the piston is arranged so that lubricant from the second port is injected onto the piston pin as the piston moves past the second port.

8. The engine of claim 1, wherein the lubrication system additionally comprises a lubricant pump, the pump having a first delivery port for delivering lubricant to the first lubricant insertion port and a second delivery port for delivering lubricant to the second lubricant insertion port.

9. The engine of claim 8, wherein a volume of lubricant supplied through the first delivery port is different than a volume of lubricant supplied through the second delivery port.

10. The engine of claim 9, wherein a volume of lubricant supplied through the first delivery port is greater than a volume of lubricant supplied through the second delivery port.

11. The engine of claim 1, wherein the lubrication system additionally comprises a first lubricant pump and a second lubricant pump, the first lubricant pump configured to deliver lubricant to the first lubricant insertion port and the second lubricant pump configured to deliver lubricant to the second lubricant insertion port.

12. The engine of claim 11, wherein one of the lubricant pumps is a mechanical pump and another other of the lubricant pumps is an electromagnetic pump.

13. The engine of claim 1 in combination with a marine drive comprising a marine propulsion device.

14. An internal combustion engine configured to drive a propulsion device, the engine comprising a cylinder block having at least one cylinder formed therein, a cylinder liner disposed in the cylinder and defining a cylinder bore, a piston arranged within the cylinder bore to reciprocate therein, a lubricant discharge port formed through the cylinder block and opening into the cylinder, a circumferential passage formed between the cylinder and the cylinder liner, the circumferential passage arranged so as to communicate with the cylinder block lubricant discharge port, and at least one lubricant delivery hole formed through the cylinder liner and positioned to correspond with the circumferential passage, the delivery hole being offset from the lubricant discharge port.

15. The engine of claim 14, wherein the circumferential passage comprises a groove formed around an outer surface of the cylinder liner.

16. The engine of claim 14, wherein the cylinder has an uppermost wall portion, and one of the lubricant delivery holes is positioned in the uppermost wall portion.

17. An internal combustion engine adapted to drive a propulsion unit, the engine comprising a crankcase at least partially enclosing a crankshaft, a cylinder block having at least one cylinder bore, a piston arranged within the cylinder bore to reciprocate therein, and a lubrication system, the lubrication system comprising means for delivering a first volume of lubricant to engine components in the crankcase and separately delivering a second volume of lubricant to engine components within the cylinder bore.
